(19) United States
(12) Patent Application Publication
(10) Pub. No.: US 2013/0308190 A1
(43) Pub. Date: Nov. 21, 2013

(54) Method for Providing Fog Free Shower Mirror

(71) Applicant: The Cumberland Companies, LLC, (US)

(72) Inventor: William G. Vogel, Knoxville, TN (US)

(73) Assignee: The Cumberland Companies, LLC, Knoxville, TN (US)

(21) Appl. No.: 13/855,396

(22) Filed: Apr. 2, 2013

Related U.S. Application Data
(60) Provisional application No. 61/619,028, filed on Apr. 2, 2012.

(51) Int. Cl. G02B 27/00

(52) U.S. Cl. CPC G02B 27/0006
USPC 359/512

(57) ABSTRACT

A method for achieving and maintaining a substantially fog-free mirror surface in a hot water shower. The method involves locating a thin acrylic mirror in a flow of hot water having a water temperature in an enclosed shower for a treatment period of time of 10 seconds or less to treat the mirror to bring the mirror to a temperature substantially the same as the water temperature to achieve a substantially fog free mirror surface. The treated mirror maintains the substantially fog free mirror surface for a period of time at least 18 times the treatment time.

### CROSS-REFERENCE TO RELATED APPLICATION

This application claims priority to U.S. Provisional Application Ser. No. 61/619,028 filed Apr. 2, 2012, and entitled FOG FREE SHOWER MIRROR, incorporated by reference herein in its entirety.

### FIELD

The present disclosure relates to mirrors for use in a hot water shower. More particularly, the disclosure relates to a method for achieving and maintaining a substantially fog-free mirror surface in a hot water shower setting.

### BACKGROUND AND SUMMARY

Shaving in the shower is popular and provides a favorable shaving environment in that the shower conditions make facial hair easier to shave. Typically, a hot water shower is at least about 100° F. or hotter, as compared to a room temperature typically from about 60 to about 80° F. The temperature difference and humidity of the hot shower causes condensation on any mirror surfaces located in the shower. Attempts have been made to provide shaving mirrors that remain substantially fog-free in a hot water shower setting, but, such mirrors do not function as intended or are otherwise cumbersome and difficult to use. Accordingly, improvement is desired in achieving and maintaining a substantially fog-free mirror surface in a hot water shower setting.

The disclosure advantageously provides methods for achieving and maintaining a substantially fog-free mirror surface in a hot water shower setting.

In one aspect, the method includes the steps of providing a mirror consisting of a mirrored acrylic sheet having a thickness of about 0.2 inches or less; locating the mirror in a flow of hot water having a water temperature in an enclosed shower for a treatment period of time of 10 seconds or less to treat the mirror to bring the mirror to a temperature substantially the same as the water temperature to achieve a substantially fog free mirror surface; locating the treated mirror in the enclosed shower outside of the flow of hot water, wherein the treated mirror maintains the substantially fog free mirror surface for a period of time at least 18 times the treatment time.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIGS. 1A and 1B show a mirror located in a hot shower environment having a fogged mirror surface.

FIG. 2 shows a step of treating the mirror of FIGS. 1A and 1B in accordance with the disclosure so as to provide it in a substantially fog-free state in the hot shower environment.

FIG. 3 shows a mirror after treatment in accordance with the disclosure to be in a substantially fog-free state in the hot shower environment.

FIG. 4 shows the mirror of FIG. 3 in use for providing a substantially fog-free mirror surface for shaving in a hot shower environment.

### DETAILED DESCRIPTION

With reference to the drawings, there is shown a mirror 10 located in a hot shower environment 12. The mirror 10 has not been treated in accordance with the disclosure and has a mirror surface 14 that is substantially fogged over and substantially not providing a reflective image and unsuitable for use as a mirror for one to see their image and shave in the hot shower environment.

As used herein, the terminology hot shower environment will be understood to be the humid environment typical of an enclosed shower having hot water HW flowing from an elevated shower head SH at a water temperature of at least about 100° F. or hotter, typically averaging at least about 107° F., and often hotter. The shower enclosure is typically provided by a drained floor and surrounding walls having a door, with the uppermost portion of the walls open for venting.

The mirror 10 may be provided as by an acrylic sheet having the mirror surface 14 provided on a surface of the acrylic sheet as by a vacuum metalizing process to provide the mirror surface 14. The mirror is provided in a thickness of less than about 0.2 inches so as to be sufficiently thin to be quickly heated, as described more fully below. It is preferred that the mirror 10 has a thickness of at least about 0.05 inches so as to avoid being so thin as to easily break. In a preferred embodiment, the mirror 10 has a thickness of about 0.118 inches. The mirror 10 is desirably dimensioned to have a width of from about 3 to about 6 inches, and a length of from about 5 to about 7 inches. The mirror 10 may be otherwise configured, such as round.

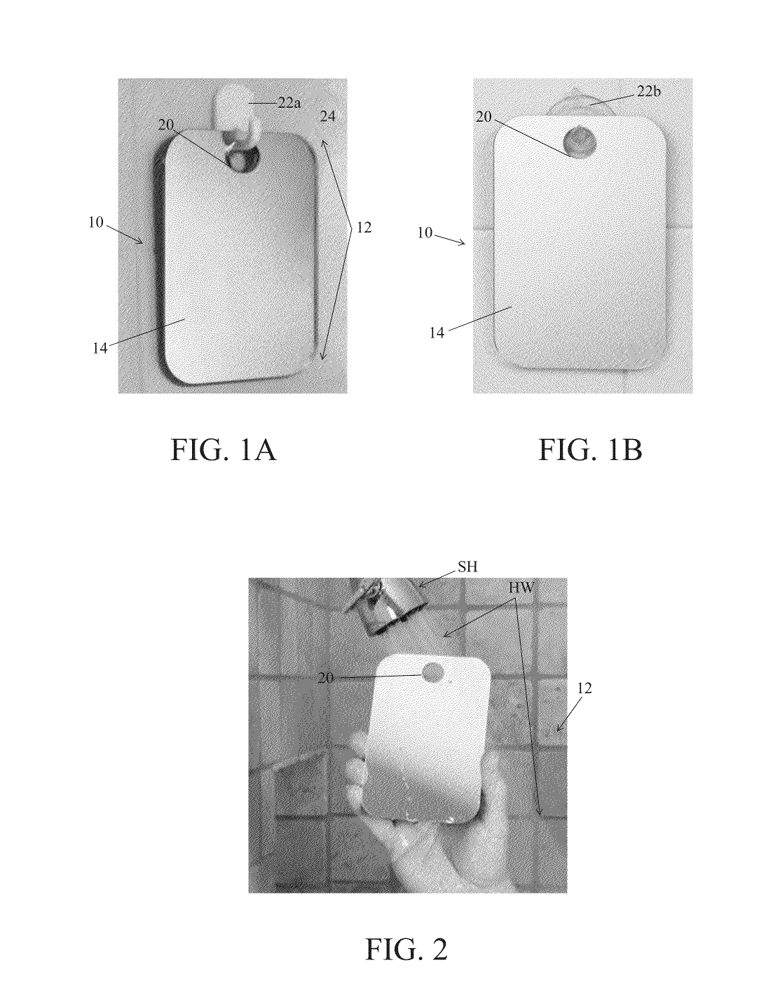

The mirror 10 includes an aperture 20 defined therethrough; preferably at an upper end of the mirror 10 so as to only minimally obstruct the mirror surface 14. The aperture 20 desirably has a diameter of about 0.75 inches. The aperture 20 is configured to enable the mirror 10 to be quickly and easily removably mounted onto a mount 22 affixed to a surface 24 of the shower environment 12, such as a wall of a shower enclosure, out of the flow of hot water HW. The mount 22 may be provided as by a plastic hook or post mounted to the surface 24 as by a suction cup (see 22b in FIG. 1B) or adhesive (see 22a in FIG. 1B). The aperture 20 and the mount 22 enable quick and easy mounting and unmounting of the mirror 10 in the enclosed shower.

In accordance with the disclosure, it has been discovered that the use of the mirror 10 in the form of a thin acrylic sheet removably mountable in the shower in conjunction with the flow of hot water HW combine to enable achievement and maintenance of a substantially fog-free mirror surface in a hot water shower setting and spaced away from the flow of hot water. It will be understood that providing a substantially fog free mirror surface will be understood to mean that the mirror is able to provide a reflective image suitable for use as a mirror for one to see their image and shave in the hot shower environment.

In this regard, as shown in FIG. 2, the mirror 10 may be removed from the mount 22 and held in the flow of hot water HW for a short period of time sufficient to bring the temperature of the mirror and the mirror surface 14 substantially to the temperature of the flow of the hot water HW. In this regard, the use of the mirror 10 as provided by a thin acrylic sheet enables rapid thermal transfer so that the temperature of mirror 10 and the mirror surface 14 rapidly equilibrate to substantially the same temperature as the flow of hot water HW. For example, it has been discovered that sufficient heating of the mirror 10 typically occurs in 10 seconds or less.

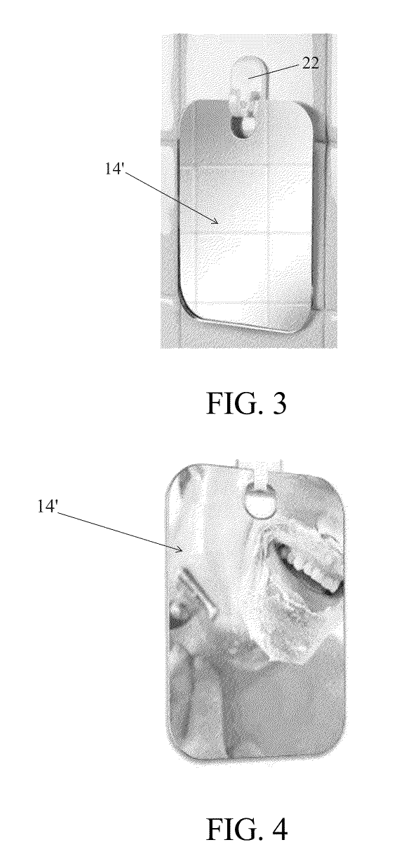

With reference to FIG. 3, the thus treated mirror 10 may then be remounted onto the mount 22. The treated mirror 10 provides a treated mirror surface 14′ that is substantially free of fog and provides a reflective surface in the shower environment suitable for shaving. As shown in FIG. 4.

It has also been discovered that the acrylic material of the mirror 10 substantially retains a suitably warm temperature so as to maintain a substantially fog free surface for the duration of a shave, up to about 3 minutes. Accordingly, it will be appreciated that the method enables a treatment time of 10 seconds or less to achieve substantially fog free mirror conditions of at least about 3 minutes, or 18 times the treatment time.

However, in the event the mirror surface begins to fog, the mirror 10 may be easily removed from the mount 22 and re-treated by holding briefly in the flow of hot water HW. In this manner, the method of the disclosure, utilizing the thin acrylic mirror 10, enables a user to achieve and maintain a substantially fog-free mirror surface in a hot water shower setting. The ability of the mirror 10 to be easily mounted and unmounted is also desirable to facilitate removal of the mirror for cleaning, and enables portability so the mirror can be carried on trips and the like. In such circumstances, a suction cup mount can also easily be carried, or the mirror can be held by hand, which provides a very potable manner of mounting.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated.

1. A method for achieving and maintaining a substantially fog-free mirror surface in a hot water shower, the method including the steps of: providing a mirror consisting of a mirrored acrylic sheet; locating the mirror in a flow of hot water having a water temperature in an enclosed shower for a treatment period of time of 10 seconds or less to treat the mirror to bring the mirror to a temperature substantially the same as the water temperature to achieve a substantially fog free mirror surface; locating the treated mirror in the enclosed shower outside of the flow of hot water, wherein the treated mirror maintains the substantially fog free mirror surface for a period of time at least 18 times the treatment time.

2. A method for achieving and maintaining a substantially fog-free mirror surface in a hot water shower, the method including the steps of: disposing a mirror consisting of a mirrored acrylic sheet having a thickness of about 0.2 inches or less with an aperture adjacent an end of the mirror on a mount affixed to a shower surface by placing the aperture about the mount; removing the mirror from the mount; locating the mirror in a flow of hot water having a water temperature in an enclosed shower to treat the mirror to bring the mirror to a temperature substantially the same as the water temperature to achieve a substantially fog free mirror surface; and locating the treated mirror in the enclosed shower outside of the flow of hot water, wherein the treated mirror has the substantially fog free mirror surface.

3. The method of claim 2, wherein the mount comprises a suction-cup mount.

4. The method of claim 2, wherein the mount comprises an adhesively mounted hook.

5. A method for achieving and maintaining a substantially fog-free mirror surface in a hot water shower, the method including the steps of: disposing a mirror with an aperture adjacent an end of the mirror on a hook or post affixed to a shower surface by placing the aperture about the hook or post; removing the mirror from the hook; locating the mirror in a flow of hot water having a water temperature in an enclosed shower to treat the mirror to bring the mirror to a temperature substantially the same as the water temperature to achieve a substantially fog free mirror surface; locating the treated mirror in the enclosed shower outside of the flow of hot water, wherein the treated mirror has the substantially fog free mirror surface; and returning the mirror to the hook or post.
